(19) United States
(12) Patent Application Publication
(10) Pub. No.: US 2006/0085326 A1
(43) Pub. Date: Apr. 20, 2006

(54) Method and device for enabling electronic transactions

(75) Inventor: Bill Linden, Uppsala (SE)

Correspondence Address: YOUNG & THOMPSON, 745 SOUTH 23RD STREET, 2ND FLOOR, ARLINGTON, VA, 22202, US

(73) Assignees: LAWAL EKONOMI, Lidingo (SE); JURIDIK LARS WALDENSTROM, Lidingo (SE); BILL LINDEN, Uppsala (SE)

(21) Appl. No.: 10/532,100

(22) PCT Filed: Oct. 21, 2003
(86) PCT No.: PCT/SE03/01623

§ 371 Date: Apr. 21, 2005

(30) Foreign Application Priority Data
Oct. 22, 2002 (SE) 0203114-4

(51) Int. Cl. G06Q 40/00

(52) U.S. Cl. 705/39

(57) ABSTRACT

Method for payment through the Internet while utilizing a multi position character code, wherein a first Internet connection is established between a customer and a merchant and a payment order is put by the customer. A first section of the character code is transferred from a computer associated to the customer to a computer associated to the merchant through the first Internet connection. The computer associated to the merchant transfers the first section of the character code to a computer associated to a payment agency through a separate connection, and a second Internet connection between the payment agency and a customer is initiated by the computer associated to the merchant. At least a further section of the character code is transferred from the computer associated to the customer to the computer associated to the payment agency, and the payment is then executed by the computer associated to the payment agency.

### TECHNICAL FIELD

The device relate to a method for a payment through the Internet. The payment is part of a transaction which in all parts or essential parts takes place through the Internet. A product or a service is shown by a merchant and is selected by a customer. The payment is performed when the merchant deducts a payment from an account associated to a credit card or similar device.

### PRIOR ART

A conventional type of purchase and payment through the Internet can be performed in the following way. A customer establishes contact with a web site of a merchant through the Internet. On the web site the customer is able to choose a product or a service to be purchased. The customer will provide personal data to an extent that is required by the merchant, and also a multi position character code associated to a credit card, debit card or corresponding device. The character code normally is a set of numbers. Normally a debit card or credit card is made out by a credit card provider such as a bank or a major sales company, such as HM©, IKEA© or SAAB© and normally it is associated to a credit card company, such as VISA®, MASTERCARD® or AMERICAN EXPRESS®.

By providing the multi position character code and optionally other data such as the name of the credit card holder, credit card company and expiration date of the card, the customer will allow the merchant to debit an account of the customer associated to said credit card with the purchase-sum. Payments of this kind are regular, but not as usual as previously assumed. One reason is that unreliable merchants are able to use the character code in an unauthorized way, for instance by debiting the account with another amount than the purchase-sum. It may also be that the merchant brings about the character code to other, which in a corresponding way uses the information in an unauthorized way.

If the multi position character code ends up in the wrong hands it can be used in connection with conventional purchases through the Internet from reliable merchants. Credit cards and debit cards can be provided with a security code besides the multi position character code. Normally the security code is a further character code printed on the backside of the card which can not be accessed on a voucher or slip from a previous purchase with the card. The security code can also be a symbol. The security in connection with purchases through the Internet can be increased by requiring that the security code also is stated in connection with a purchase.

It is a known problem that the security during payments through the Internet presently is not sufficiently high or at least it is considered to lack the required security. As a result both customers and merchants will have fewer possibilities for purchases which otherwise could have been made.

### SUMMARY OF THE PRESENT INVENTION

An object of the invention is to provide a method for payments through the Internet that essentially will overcome the security problems connected to such payments. In accordance with the invention the complete character code is never transferred from the customer to the merchant but only a section thereof. The completing section is transferred in one or a plurality of steps together with other details from the customer to a payment agency, normally the credit card company or the provider of the credit card, who as a result will receive one section of the character code from the merchant and the completing section, or sections, from the customer directly.

The complete character code will never be transferred during a continuous Internet connection and as a result it can never be intercepted. The payment agency, who receives the character code from different sources during different Internet connections, will be able to debit the correct account associated to the customer by means of the complete character code. The customer is confident that the character code can not be abused.

The customer and the merchant both need to have a relation with the payment agency for carrying out the payment. As regards the customer it is only the relation normally existing, whereas the payment agency has issued or supplied the credit card. If the payment agency and the customer have an agreement to use the card for payments on condition that a further code is provided, such as a so called PIN-code, such a further code can be provided in connection with the customer providing the remaining section of the character code. As an alternative the security code can be used to complete the code.

### BRIEF DESCRIPTION OF THE DRAWINGS

The invention will be described in detail below with reference to practical embodiments and to the accompanying drawings, wherein

FIG. 1 schematically shows a hardware that can be used for utilizing the method in accordance with the invention,

FIG. 2 schematically shows an information carrying card which can be used in utilizing the method in accordance with one embodiment of the invention,

FIG. 3 schematically shows a first step when payment is made with a method in accordance with one embodiment of the invention,

FIG. 4 schematically shows a second step during payment in accordance with FIG. 3,

FIG. 5 schematically shows a third step during payment in accordance with FIG. 3, and

FIG. 6 schematically shows a fourth step during payment in accordance with FIG. 3.

### DETAILED DESCRIPTION

The hardware shown in FIG. 1 comprises a first computer 10 or a corresponding electronic device, which is connected to the Internet 12 through a first connection 11. The first computer 10 is in a conventional way provided with means for entering information, such as keyboard or keypad. It is possible to use also voice receiving means and biometric systems. The connection to the Internet can be by wire, as indicated in FIG. 1, by optical fiber or wireless. The first computer 10 is associated to a customer.

A second computer 13 is associated to a merchant and is connected to the Internet 12 through a second connection 14. Also said connection can be by wire, optical fiber or wireless. The merchant has established an Internet connection so as to make web sites or corresponding documents accessible to potential customers and buyers through the Internet.

A third computer 15 which is associated to a payment agency, such as a bank, is connected to the Internet 12 through a third connection 16. The payment agency also has established an Internet connection so as to make web sites or corresponding documents in said third computer accessible for customers of the payment agency through the Internet. In FIG. 1 it is shown that the payment agency can be provided also with a transaction computer 21, which is a computer that stores account data and performs other transactions between the customers of the payment agency or between the customers and the payment agency. Some kind of connection is provided also between the transaction computer 21 and the third computer 15.

Also other networks than the Internet can be used in a connection for utilizing the method in accordance with the invention. All connections can also be wireless. The computers included and described above can be conventional computers or can be computers especially adapted for communication and transactions through a network.

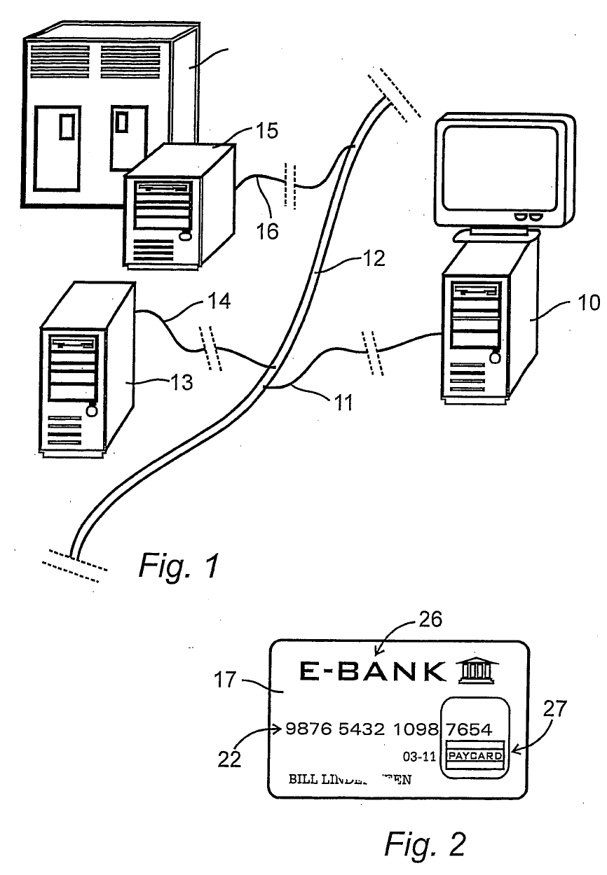

FIG. 2 shows schematically a card 17 that can function as a carrier of or be associated to a multi position character code 22. Normally, the character code is associated also to a physical persona and to a bank account or a transaction account of a payment agency. In a common embodiment the character code is 16 characters wide and the characters are numbers. In the shown embodiment the card 17 carries a print of the name of the payment agency. It is also common that the card is provided with a symbol associated to said payment agency.

The card 17 also indicates a credit card drawer 26 which in this case is a bank named E-BANK. The card also indicates the name of a credit card company 27, in this embodiment named PAYCARD.

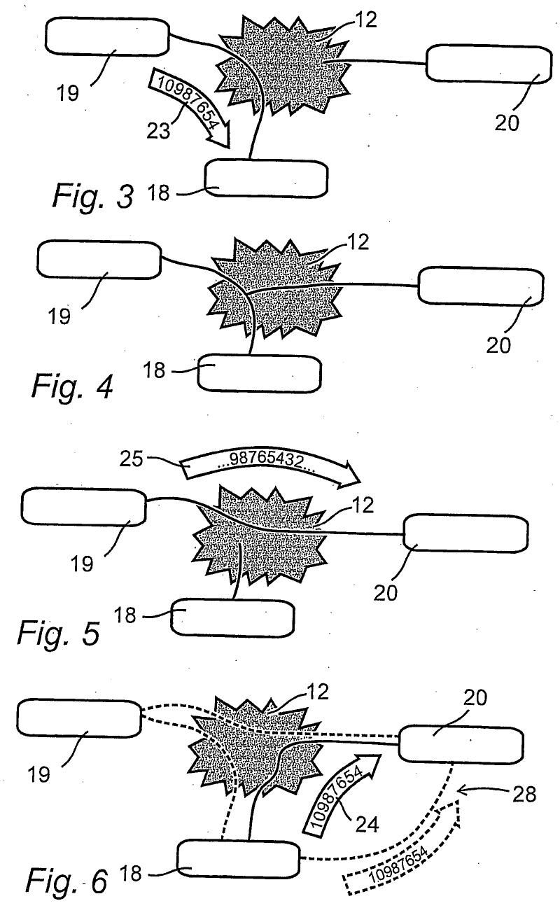

When performing a payment in accordance with the invention in one embodiment the following steps are taken with reference to FIG. 3-FIG. 6. A merchant 18 makes accessible at least one web site on the Internet 12. A customer 19 establishes in a first step a first connection with the merchant through the Internet and chooses an article or a service or places another type of order through the web site of the merchant. The customer is provided with a card 17 of the type described above. To confirm at least one part of a purchase the customer transfers a section of a character code associated to the customer to the merchant through the Internet.

In the embodiment shown in FIG. 3-FIG. 6 the last eight numbers 10987654 of the sixteen position character code are transferred as indicated with a first arrow 23. In other embodiments fewer or more numbers can be transferred, and it is possible also to transfer the first number or other numbers. As a result merchant will receive during the first connection only a section of the character code that is required to make a payment agency 20 accepting a debit from an account. It is also not possible to access the entire character code by intercepting the Internet connection between the customer and the merchant. In connection with placing the order the customer will transfer also other data. Such data will include the name of the credit card company, the name and the address of the customer and in some cases also further information.

The merchant will establish in a second step in accordance with FIG. 4 a second connection through the Internet to the payment agency 20 or the credit card company that has been assigned by the customer and also will initiate the establishment of a connection between the customer and the payment agency. This can be done when the merchant informs the customer, that is the computer of the customer, of the address to a selected web site of the payment agency. Then the computer of the customer and a web browser or another program executing in a computer will establish a connection between the customer and the payment agency, that is between the computer of the customer and a computer of payment agency. This latter connection is indicated in FIG. 4. Now the customer is in direct contact with his payment agency. It is possible also to allow the computer of the payment agency to directly take over one end of a communication link from the merchant and to continue an established communication link between the customer and the merchant. As a result the merchant will loose his connection with the customer and will not be able to follow the further exchange of data between the customer and the payment agency as indicated in FIG. 5. Preferably the establishment of a connection between the customer and the payment agency will be done without any requirements on the customer to take any active step.

The customer will be informed by the payment agency that a section of the character code 22 is known and that it has to be completed. The customer will transfer the remaining part of the character code 22, in the shown embodiment 98765432, in one or a plurality of steps together with other appropriate data such as the period of the validity of the card 17 as indicated with a third arrow 25. During this phase also other data from the card can be transferred so as to further guarantee that the customer is indeed in possession of the card.

In connection with the transactions in accordance with FIG. 5 the merchant will establish in a fourth step, as shown in FIG. 6, a new connection with the payment agency 20 and transfers the section of the character code received from the customer 19 together with other required or appropriate data as indicated with a second arrow 24. In accordance with a common embodiment data about the merchant are transferred to allow the payment agency to arrange the payment in a correct way and also data about the transaction requested by the customer. These latter data may include an order number or similar information and the purchase-sum. These data can be transferred through a completely different type of connection than the Internet as indicated with dashed lines at 28 in FIG. 6. As a result the security can be further increased. It is possible also to use a specific safe Internet connection.

During the fourth step the previously established connection between the customer 19 and the payment agency 20 can be maintained as indicated with a dashed line in FIG. 6, or it may be interrupted. In a corresponding way the previously established connection between the customer 19 and the merchant 18 can be maintained, as indicated with a dashed line in FIG. 6, or it may be interrupted. Any interception of information is from these connections.

If the payment agency accepts to complete the transaction the customer will be debited the purchase-sum and the merchant will receive the corresponding amount. It is possible that the payment agency adds a transaction fee to either party. These transactions may take place through the transaction computer 21, cf. FIG. 1. There is transferred also an acknowledgement to the merchant for a delivery of the ordered product or service.

If the payment agency does not accept a completion of the transaction, for instance because the customer is not covered for the purchase-sum, the payment agency will instead inform the merchant that the transaction has not been completed. Also the customer can be informed.

The character code can be divided into more than two sections that are transferred in a plurality of steps. In the embodiments shown the character code is transferred in consecutive sequences of numbers. It is possible also to transfer single numbers or groups of numbers in reverse order or in other ways than in consecutive order. Such a procedure, however, will increase the demands on the customer.

1. Method for payment through the Internet (12) utilizing a multi position character code (22), including the establishment of a first Internet-connection (11) between a customer and a merchant and wherein the customer puts a payment order, characterized by the following steps.
transferring a first section of the character code to the merchant through a first connection through said first Internet connection (11),
the merchant initiating a second connection through a second Internet connection (14) between a payment agency and the customer,
the merchant transferring said first section of the character code (22) to a payment agency (20) through a separate connection,
transferring at least a further section of the character code (22) from the customer to the payment agency,
the payment agency executing the payment.

2. Method for payment through the Internet using a multi poison character code (22), including the steps of establishing a first Internet connection (11) between a customer and a merchant and the customer putting a payment order, characterized by the following steps,
transferring a first section of the character code from a computer (10) associated to the customer to a computer (13) associated to the merchant through a first connection in the first Internet connection (11),
the computer (13) associated to the merchant transferring said first section of the character code (22) to a computer (15) associated to a payment agency through a separate connection,
the computer (13) associated to the merchant initiating a second connection in a second Internet connection (14) between said payment agency and said customer,
transferring at least a further section of said character code (22) from said computer (10) associated to the customer to the computer (15) associated to the payment agency, and
the computer (15) associated to said payment agency executing the payment.

3. Method in accordance with claim 2, further including the step of transferring a consecutive sequence of numbers at the end of the character code (22) as said first section of the character code (22).

4. Method in accordance with claim 3, wherein said consecutive sequence forms one half of the character code (22).

5. Method in accordance with claim 2, further including the steps of the computer (15) associated to the payment agency taking over said first connection to establish said second connection.

6. Method in accordance with claim 2, further including the step of interrupting said first connection when said second connection is established.

7. Method in accordance with claim 2, wherein the computer (13) associated to the merchant transfers said first section of the character code (22) to a computer (15) associated to said payment agency through a separate Internet connection.
